(19) United States
(12) Patent Application Publication
(10) Pub. No.: US 2007/0195389 A1
(43) Pub. Date: Aug. 23, 2007

(54) METHOD FOR THE CALCULATION OF, STORAGE MEDIUM FOR AND DEVICE FOR THE READ-OUT OF COMPUTER-GENERATED HOLOGRAMS ON A NON-PLANAR SURFACE

(75) Inventors: Steffen Scheibenstock, Stuttgart (DE); Stefan Borgsmuller, Heidelberg (DE)

Correspondence Address: NORRIS, MCLAUGHLIN & MARCUS, 875 THIRD AVE, 18TH FLOOR, NEW YORK, NY, 10022, US

(73) Assignee: TESA SCRIBOS, Heidelberg (DE)

(21) Appl. No.: 11/677,440

(22) Filed: Feb. 21, 2007

(30) Foreign Application Priority Data
Feb. 22, 2006 (EP) 06003545.8

(51) Int. Cl. G03H 1/08

(52) U.S. Cl. 359/9; 359/14

(57) ABSTRACT

The invention relates to a method for calculating a light field which propagates between a non planar surface of a computer-generated hologram and a planar reconstruction surface, in which an intermediate plane arranged in front of the hologram is defined, in which the propagation of the light field between the reconstruction plane and the intermediate plane is calculated by means of a transformation, and in which the propagation of the light field between the non-planar hologram surface and the intermediate plane is estimated. This method solves the technical problem of taking account of the geometrical distance differences that arise on account of unevennesses of the storage medium ill the calculation of the hologram function and the reconstruction or read-out and at the same time of specifying a fast algorithm. The invention also relates to a method for producing a hologram, storage medium and a device for reading out a hologram.

The present invention relates to a method for the calculation of, a storage medium for and a device for the read-out of computer-generated holograms on a non-planar surface.

Computer-generated holograms comprise one or more layers of dot matrices or dot distributions which, in the event of illumination with a preferably coherent light beam, lead to a reconstruction of the items of information coded in the hologram. In this case, the dot distribution may be calculated as an amplitude hologram, phase hologram or as a kinoform. In order to produce computer-generated holograms, the latter are first calculated and subsequently written to a storage medium by a suitable writing device by means of dotwise introduction of energy. The resolution of the dot matrix that arises in this case may lie within the range down to less than 1 μm. Consequently, holograms having a high resolution can be written in a confined space, the information of which holograms can only be read out by illumination with a light beam and reconstruction of the diffraction pattern. In this case, the size of the holograms, may be between less than 1 mm² and plural 1 cm².

The computer-generated holograms described above can be combined with a directly visible item of information (microscript, microimages).

A major advantage of the computer-generated holograms is that each hologram can be calculated individually. Consequently, holograms comprising consecutive numbers or production parameters, for example can be generated in series. Holograms of this type can therefore be used in particular as security features on packaging, credit cards, entrance tickets or the like. By means of a suitable read-out device, the security features of the hologram can be read out and the authenticity and individuality of the security feature can be checked in a simple manner.

When writing or read-out by means of a light beam is described below, a laser beam in the visible wavelength range is generally meant. Nevertheless, the present invention is not restricted to the application of visible light. In principle, the invention can be applied with electromagnetic radiation in a wide wavelength range.

Furthermore, a light field is to be understood below as an electromagnetic field which is determined by the specifications of amplitude, wavelength, phase and propagation direction in a surface. For computer-aided calculation, for this purpose, the surface, generally a planar surface, is divided into individual surface units or pixels, usually in the form of a raster, and the values of the parameters of the light field are defined in each surface unit. The totality of all the surface units then represents the light field.

The computer-generated holograms are generally calculated for a planar hologram surface because it is only in this case that the fast algorithms of Fourier transformation and other transformations can be used to calculate the propagation of the light field between the hologram surface and the planar reconstruction plane. WO 03/014837 shows an example of a calculation of the light propagation by means of transformations.

Therefore, the holograms are also applied on planar storage media and some effort is made to keep the storage medium or the hologram plane in a plane. This is complicated, particularly when the storage medium is fixed on a flexible material such as a label or a thin or rough packaging material.

Generally, computer-generated holograms are susceptible to deformations and associated changes in the angle of incidence of the read beam on the surface. These changes regularly lead to a deterioration in the quality of the reconstruction through to illegibility of the reconstruction.

The planar hologram surfaces discussed above therefore have to be produced and maintained with a great accuracy in a storage medium. Deviations from the plane, viewed in the direction of the surface normal, of the order of magnitude of more than 10% of the wavelength of the light already have a significant effect on the quality of the reconstruction. Deviations of greater than half a wavelength already bring about considerable losses in the quality of the reconstruction. Deviations starting from a wavelength of greater than one wavelength then result in the hologram being unreadable. Therefore, when mention is made of non-planar hologram surfaces below, the hologram surfaces have deviations of the order of magnitude of at least 10% of the wavelength of the light used for read-out, preferably greater than half a wavelength and in particular greater than one wavelength. In principle, the deviations are not subject to upward limitation, but a practicable range of deviations from planarity lies below 200 wavelengths.

If the surface of the hologram is deliberately chosen to be non-planar, then this gives rise to a lack of sharpness in the reconstruction that cannot be compensated for without additional outlay. If the surface of the hologram is cylindrical, for example, then a lack of sharpness arises in the direction perpendicular to the cylinder axis.

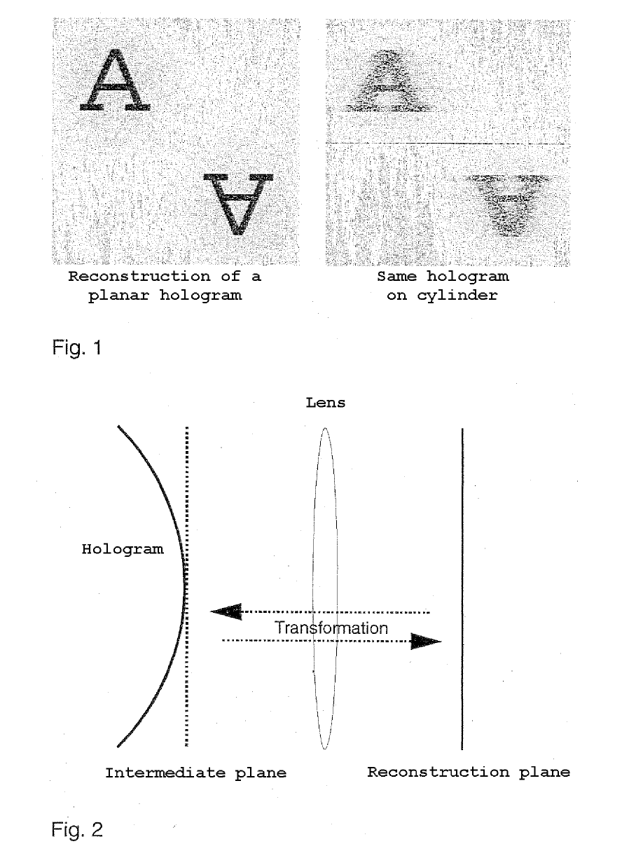

This is illustrated in FIG. 1 by way of example. The left-hand part illustrates the reconstruction of a normal planar hologram while in the right-hand part the same hologram has been used but it has been applied on a cylindrical surface. In this case, the cylinder axis is perpendicular and a significant blurring of the reconstruction of the letter “A” can be discerned perpendicular to the cylinder axis; the reconstruction thus has a poor resolution transversely with respect to the perpendicular cylinder axis. The illustrations of the reconstructions show, moreover, in each case the plus first order in the top left corner and in each case the minus first order of the reconstruction in the bottom right corner.

It is known from the literature that the direct light propagation between the non-planar surface of the hologram and the reconstruction is calculated completely. However, this calculation does not permit the application of a Fourier transformation or similar transformation and is therefore very time-consuming. This type of calculation cannot, therefore, be used for example in a production process with a high cycle rate in which individual holograms are calculated and written.

The prior art furthermore discloses a plurality of writing devices for writing computer-generated holograms which write the optical structures of the holograms in planar storage media. By way of example, reference is made in this respect to the documents WO 02/079881, WO 02/079883, WO 02/084404, WO 02/084405 and WO 03/012549.

A plurality of reading devices are likewise known which are suitable, by illuminating the hologram surface by means of a light beam and a suitable optical arrangement, for making the reconstruction visible or electronically representable by means of recording means and evaluatable. By way of example, in this context, reference is made to the documents DE 101 37 832, WO 02/084588 and WO 2005/111913.

The writing and reading devices mentioned are in each case described for writing to or reading from planar storage media, but can be used for non-planar holograms under the conditions described below.

DE 102 36 891 discloses a non-planar holographic-optical storage medium and a method for the production thereof, in which a computer-generated hologram is exposed into the photosensitive layer of the element. For this purpose, in a first step, first of all the photosensitive layer is exposed in a curved state with interfering light beams. For a reconstruction of the hologram, the optical layer then has to be brought into the curved form again because the hologram cannot be read out in the case of a planar form.

Therefore, the present invention is based on the technical problem of taking account of the geometrical distance differences that arise on account of unevennesses of the storage medium in the calculation of the hologram function and the reconstruction or read-out and at the same time of specifying a fast algorithm. The technical problem likewise consists in also compensating for the distance differences in the case of a read-out device for holograms of this type. The technical problem likewise relates to a production method and a storage medium for holograms of this type.

The present invention solves this technical problem in principle by virtue of the fact that the propagation time differences of the light that arise as a result of the lack of planarity of the hologram surface and the resultant phase shifts of different regions of the light field with respect to one another are taken into account in the calculation of the hologram function and/or in the calculation of the reconstruction. The same applies to a suitable reading device; here the phase shifts resulting from the lack of planarity are at least partly compensated for by means of a suitable optical means. The basic principle mentioned may also be referred to as phase-matched calculation of the hologram function and the reconstruction or read-out as phase-matched read-out of the hologram.

The technical problem presented above is therefore solved by means of a method for calculating a light field which propagates between a non-planar surface of a computer-generated hologram and a planar reconstruction surface, in which an intermediate plane arranged in front of the hologram is defined, in which the propagation of the light field between the reconstruction plane and the intermediate plane is calculated by means of a transformation,and in which the propagation of the light field between the non-planar hologram surface and the intermediate plane is estimated.

The advantage of the abovementioned method is that the greatest portion of the light propagation between the reconstruction plane and the intermediate plane can be calculated by means of the known transformation methods, while the lesser portion of the light propagation is merely estimated. It has been found in this case that the inaccuracies accepted as a result of the estimation do not lead to a loss of resolution or sharpness in the reconstruction, and that the calculation can be carried out at a high speed.

The method according to the invention can be used, then, both for the calculation of the hologram function, that is to say the phase and/or amplitude information of the computer-generated hologram, proceeding from a predetermined reconstruction and for the calculation of the reconstruction in the reconstruction plane proceeding from a hologram function and an incident light wave.

Firstly, therefore, a method for the calculation of a computer-generated hologram arranged on a non-planar surface is specified,
a) in which, on the basis of the information to be reconstructed, the light field in the reconstruction plane is determined, and in which the light field of a read beam is determined in the non-planar surface of the computer-generated hologram,
b) in which the light field in the intermediate plane arranged in front of the hologram is calculated from the propagation of the light field between the reconstruction plane and the intermediate plane, and
c) in which the light field in the non-planar surface of the computer-generated hologram is estimated proceeding from the intermediate plane and the estimated light field is superimposed with the light field of the read beam in order to calculate the phase and/or amplitude information of the hologram.

Furthermore, a method for the calculation of a reconstruction of a computer-generated hologram arranged on a non-planar surface, illuminated by an incident light wave is specified,
d) in which the light field of an incident light wave in the non-planar surface of the hologram is calculated by a superimposition of the impinging light field and the phase and/or amplitude information of the hologram,
e) in which the light field in the intermediate plane arranged in front of the hologram is estimated proceeding from the non-planar surface of the hologram, and
f) in which the light field in the reconstruction plane is calculated from the propagation of the light field between the intermediate plane and the reconstruction plane.

Furthermore, the incident light wave and the resultant amplitude and phase distribution on the hologram surface can be calculated by a further configuration of the method,
g) in which the light field of a read beam is calculated or defined in the intermediate plane, and
h) in which the light field impinging in the non-planar surface of the hologram is estimated proceeding from the intermediate plane.

In this case, the light field in the intermediate plane can be calculated by a calculation of the light propagation of a light wave as far as the intermediate plane. The light field in the intermediate plane can likewise be defined as a pure plane wave, that is to say be defined by definition of the parameters of the light field.

The methods described above are preferably used for calculating a reflection hologram or the reconstruction thereof. This is because in the case of a reflection hologram, the light field of the read beam and the light field of the reconstruction of the hologram pass through essentially the same spatial volume, with the result that the calculation of the light propagation can be carried out equally with application of the splitting into a region between non-planar hologram surface and intermediate plane and between the intermediate plane and the reconstruction plane.

In a preferred form, a phase difference field is calculated from the wavelength of the light and the distribution of the propagation time differences of the light between the intermediate plane and the hologram on the non-planar surface. The phase difference field only has to be calculated once and can be reused for each iteration of the method.

Afterwards, in step c) the light field in the non-planar surface of the hologram is estimated by a superimposition of the light field in the intermediate plane with the phase difference field. This super-imposition is performed in a manner dependent on the propagation direction of the light field and the calculated phase difference in the form of an addition or subtraction of the phase difference field.

The estimation is therefore reduced to a pure addition or subtraction of two phase fields and hence does not represent a factor that limits the speed of the calculation.

Likewise, in step e), the light field in the intermediate plane may be estimated by a super-imposition of the light field in the non-planar surface of the hologram with a phase difference field.

The same applies to step h), wherein the light field in the non-planar surface of the hologram is estimated by a superimposition of the light field in the intermediate plane with a phase difference field.

A particular feature of the estimation with a phase difference field is that the values of the phase difference field only depend on the distances between the points of the intermediate plane and the non-planar surface and on the wavelength used when reading the hologram. If the above method is used to calculate a hologram for a specific non-planar surface and a specific wavelength of the read beam, and if said hologram is furthermore applied to a non-planar surface which has a modulation depth of the distances to the intermediate plane that is smaller by a proportionality factor relative to the original non-planar surface, then although the hologram can no longer be read with a light beam having the original wavelength, it can be read with a light beam whose wavelength is shortened by the above proportionality factor.

Furthermore, it is preferred for the light field of the read beam to be defined in the intermediate plane as a plane wave, and for the read beam to be taken into account in the calculation by a doubling of the phase difference field between the intermediate plane and the hologram surface and for the light field of the read beam to be ignored afterwards. This effect that occurs precisely in the calculation of a reflection hologram can therefore be used for a very effective calculation of the light propagation.

In the configuration of the non-planar hologram surface, it is preferred for the non-planar surface to be able to be calculated or approximated by means of a mathematical and/or numerical function. It is then readily possible to incorporate the lack of planarity of the surface into the algorithm without a further loss of accuracy occurring. Therefore, the methods described can initially be applied in an advantageous manner in the case of cylindrical surfaces, spherical surfaces, parabolic surfaces, sinusoidal surfaces or combinations of these surface types. The surface types mentioned can be exactly represented mathematically and do not require approximation. Furthermore, holograms can also be calculated on irregularly non-planar surfaces as long as the surface can be detected in a suitable manner and be transferred into a numerical function with a sufficient spatial resolution.

The description of the invention below on the basis of a cylindrical surface constitutes a simplification of the description, but is not to be understood as restrictive for the description of the invention.

In a further preferred configuration of the invention, the phase shift caused by an optical element arranged in the beam path is taken into account. As a result, it is possible, by way of example, in the case of a cylindrical surface of the hologram, to arrange a cylindrical lens in the beam path, which lens at least partially compensates for the phase shift of the phase difference field. In this case, the phase differences will turn out to be small, which are taken into account in the estimative calculation of the light field on the non-planar hologram surface or in the intermediate plane.

The calculation of the propagation of the light field between the reconstruction plane and the intermediate plane arranged in front of the hologram may be calculated with the aid of the known transformations, in particular a Fourier transformation, a fast Fourier transformation, a Fresnel transformation or a near-field solution.

The method can likewise be used to calculate the holograms in the known formats. In particular, these are amplitude and phase holograms and also kinoforms, realized as grey-scale value distributions or as binary distributions, calculated in non-optimized or optimized form for the Fourier, Fresnel or near-field area.

The holograms can be coded during the calculation, in which case it is possible to apply, in particular, a coding as an amplitude hologram, as a phase hologram or as a combination of amplitude hologram and phase hologram. In particular, it is also possible to use binary coding, which can easily be produced in a writing operation by means of one of the writing devices known per se.

Owing to the high calculation speed described above, it is possible in the case of the present invention, too, to use an optimization algorithm for the calculation of the hologram. Despite the increased computation duration, such an optimization can be used in order to calculate in real time data regarding individualized computer-generated holograms on non-planar surfaces. For the optimization of the hologram, it is possible to use a generalized Gerchberg-Saxton algorithm as iterative optimization or a direct binary search as non-iterative optimization. These techniques are known per se, but this is the first time they are applied to the calculation of holograms on non-planar surfaces.

The technical problem presented above is also solved according to the invention by means of a method for producing a computer-generated hologram on a non-planar surface, in which the hologram is calculated with the aid of one of the methods described above, in which the hologram is written to a storage medium arranged in planar fashion with the aid of a writing device, and in which the planar storage medium is fixed on a non-planar surface, whereby the material layer of the storage medium that carries the hologram assumes the non-planar form.

As a result, it is possible for the first time to calculate, at short time intervals, individual computer-generated holograms for a cylindrical surface, for example, which are firstly written to a storage medium arranged in planar fashion so as then to be applied to a cylindrical object.

A further particular feature consists in the fact that the hologram is read out from the planar storage medium and reconstructed for quality control, the lack of unevenness of the hologram surface during read-out from the planar storage medium being produced with the aid of an optical means, for example a spherical lens or a cylindrical lens.

The technical problem presented above is also solved by means of a storage medium for a computer-generated hologram, having at least one optically variable non-planar material layer in which the hologram is written. In this case, it is preferred for the hologram to have been calculated by one of the methods described above. The storage medium is characterized in that the reconstruction of the hologram leads to a reconstruction of the information in an order, for example the plus first order, which has a better resolution in comparison with the reconstruction in the same order, for example the minus first order, with an opposite sign.

In this case, resolution is understood to mean that the sharpness of the representation varies, that is to say a varying number of details of the reconstruction of the holographically stored information can be discerned. It can also be stated that the representations of the reconstruction in the positive and negative orders are blurred to varying extents. In this respect, also see the discussions regarding the resolution of the reconstructions in connection with FIGS. 1, 7 to 10 and 12.

The lack of planarity of the material layer of the storage medium, that is to say the surface of the hologram, can be produced in two ways. The first, and particularly preferred, way is for the storage medium to comprise a flexible material and to be able to be brought from a planar extension into a non-planar, for example, curved cylindrical or spherical form. This is the case with adhesive labels, for example, which are applied to a cylindrical or spherical surface section of a workpiece.

The second way is that, in a storage medium that is planar per se, a lack of planarity can be produced by partial removal of part of a surface, to the non-planar surface of which a dot distribution of a hologram is then written. Consequently, rather than the storage medium per se, only part of the surface is non-planar.

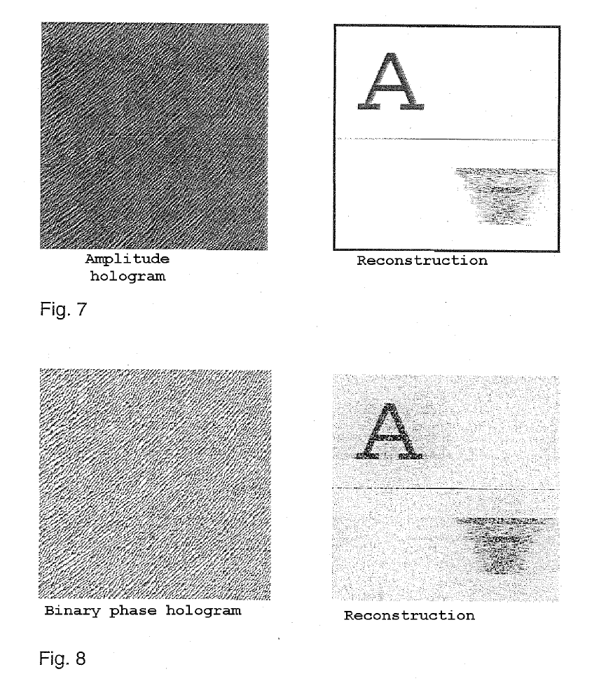

The resultant characteristic image can easily be discerned since a sharp reproduction of the information with good resolution is effected in part of the reconstruction, while the other reproduction in the order with the opposite sign is unsharp, that is to say has a lower resolution. This is explained in more detail in the specific description of FIGS. 7 to 10 and 12.

As has already been explained above, the non-planar surface can be calculated or approximated by means of a mathematical and/or numerical function. As a result it is possible to carry out the computer-aided calculation. In particular, in this case—as already mentioned—the non-planar surface is a cylindrical surface, a spherical surface, a parabolic surface or a sinusoidal surface.

The technical problem presented above is also solved by means of a device for reconstructing a computer-generated hologram arranged on a non-planar surface of a storage medium. Said device has a light source and recording means for recording the reconstruction. An optical element for at least partly compensating for the non-planar surface is provided in the beam path between the light source and the recording means. Consequently, the optical effect of the optical element can at least partly compensate for the phase shift arising as a result of the non-planar surface of the hologram.

If the optical element completely compensates for the phase shifts arising as a result of the non-planar surface, then the hologram can be calculated and written to the storage medium in a conventional manner. A phase difference field—as described above—need not be taken into account in the calculation of the hologram.

By contrast, a combination is also possible, however, if the hologram arranged on the storage medium has been calculated in a manner partly taking account of the phase shifts arising as a result of the lack of planarity of the hologram surface and if the optical element likewise partly compensates for the non-planar surface. As a result, a complete compensation of phase shifts occurs overall and the device described is able to read out the non-planar hologram.

There are various variants of the arrangement of the optical element in the beam path of the device. These are described in more detail in the description of exemplary embodiments below.

The invention is explained in more detail below on the basis of exemplary embodiments, in respect of which reference is made to the accompanying drawing, in which:

FIG. 1 shows a reconstruction of an amplitude hologram calculated for a planar hologram surface and a reconstruction for the same hologram if it assumes a cylindrical surface form,

FIG. 2 shows a schematic illustration for elucidating the terms used in the description of the method for the calculation of a computer-generated hologram and for calculating the reconstruction arising therefrom,

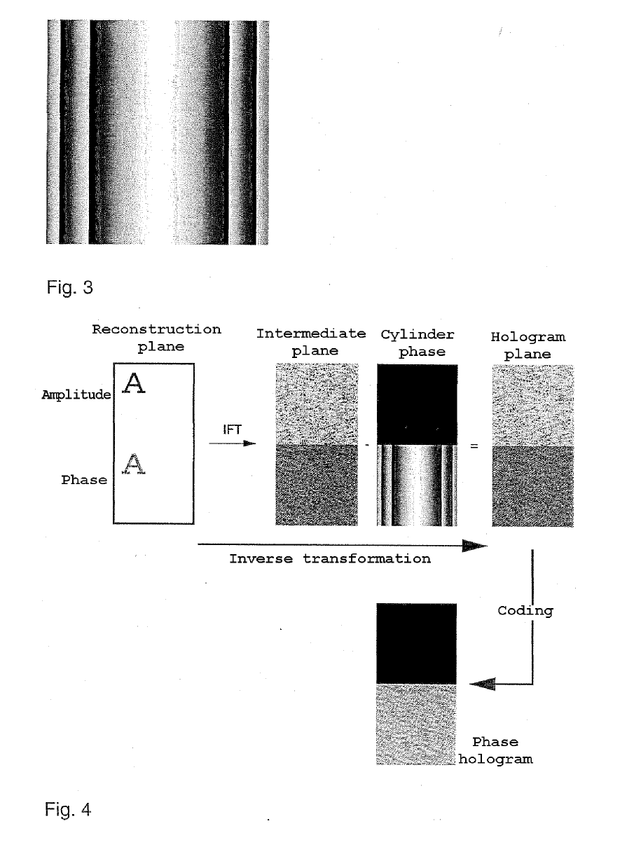

FIG. 3 shows an illustration of a phase difference field for a cylindrical hologram surface,

FIG. 4 shows an illustration of the inverse transformation proceeding from the reconstruction to the non-planar hologram surface,

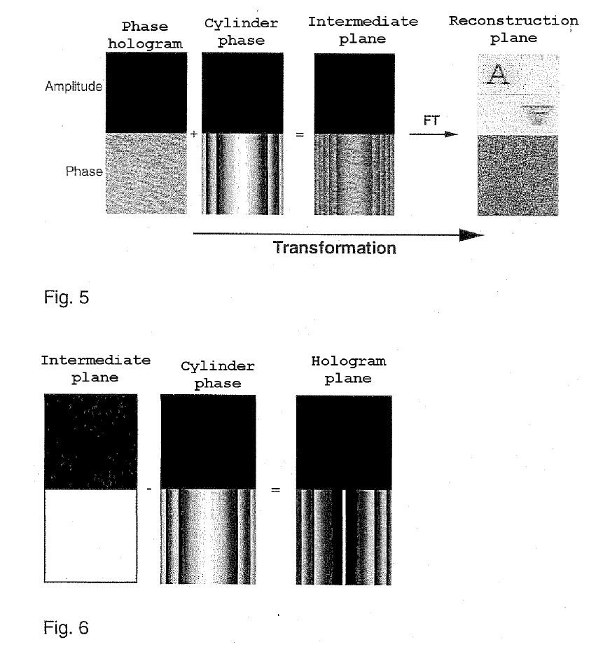

FIG. 5 shows an illustration of the transformation proceeding from the non-planar hologram surface to the reconstruction,

FIG. 6 shows an illustration of the inverse transformation of a plane wave in the intermediate plane into the non-planar hologram surface,

FIG. 7 shows an amplitude hologram calculated for a cylindrical hologram surface and the calculated reconstruction of said hologram,

FIG. 8 shows a binary phase hologram calculated for a cylindrical hologram surface and the calculated reconstruction of said hologram,

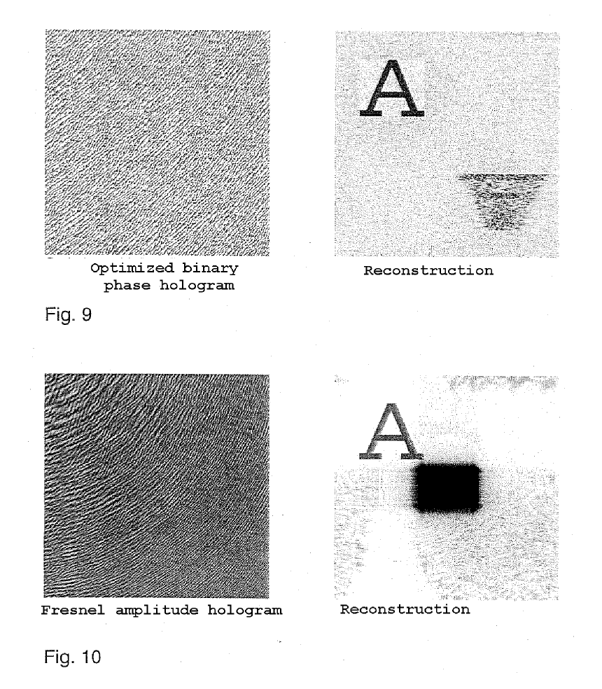

FIG. 9 shows an optimized binary phase hologram calculated for a cylindrical hologram surface and the calculated reconstruction of said hologram,

FIG. 10 shows a Fresnel amplitude hologram calculated for a cylindrical hologram surface and the calculated reconstruction of said hologram,

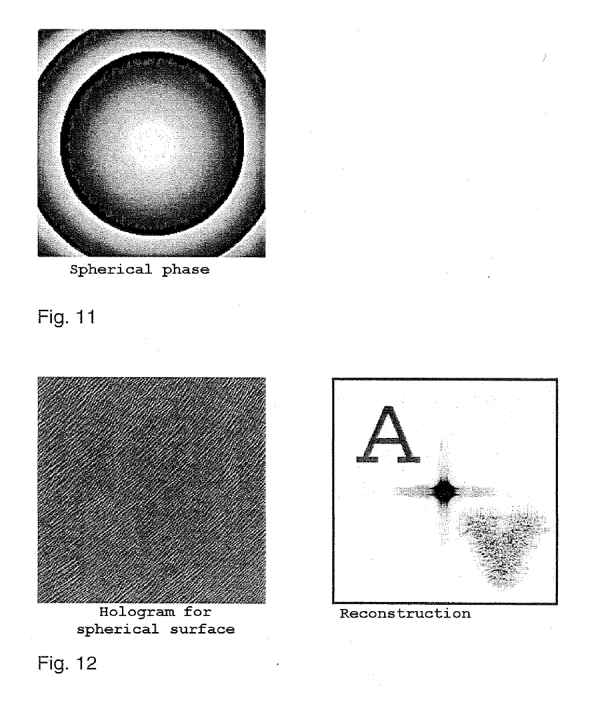

FIG. 11 shows an illustration of a phase difference field for a spherical hologram surface,

FIG. 12 shows an amplitude hologram calculated for a spherical hologram surface and the calculated reconstruction of said hologram,

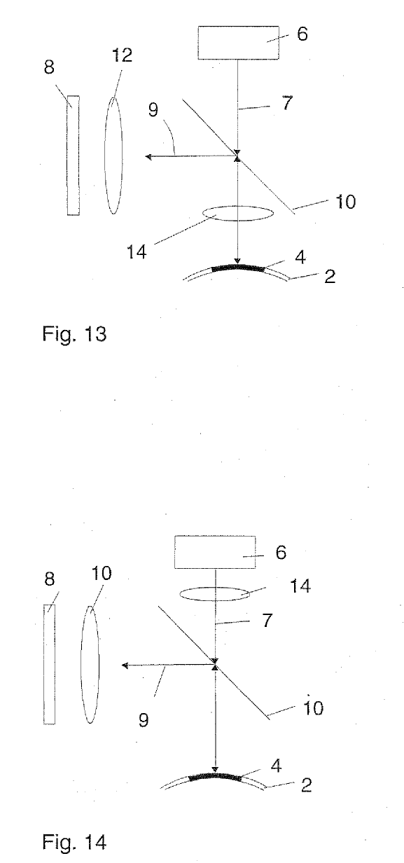

FIG. 13 shows a first exemplary embodiment of a reading device according to the invention for holograms arranged on a non-planar surface of a storage medium,

FIG. 14 shows a second exemplary embodiment of a reading device according to the invention for holograms arranged on a non-planar surface of a storage medium,

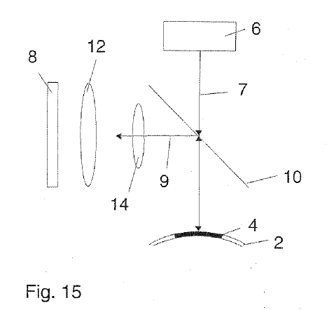

FIG. 15 shows a third exemplary embodiment of a reading device according to the invention for holograms arranged on a non-planar surface of a storage medium.

Firstly, the initial situation of the present invention is explained below with reference to FIG. 1. The methods according to the invention and also reading devices according to the invention are subsequently explained in detail.

FIG. 1 shows a known reconstruction of a computer-generated hologram, which in the present case comprises the imaging of the letter “A”. The left-hand half of FIG. 1 shows the reconstruction of the hologram while the hologram is situated in a planar position. In this case, planar position means that the material layer of the storage medium that contains the hologram information is arranged essentially in one plane.

The right-hand half illustrates the reconstruction of the same hologram, where the material layer of the storage medium that carries the hologram information has assumed a cylindrical form. By way of example, the storage medium that is planar per se has been applied to a cylindrical surface of a workpiece, the cylinder axis being oriented perpendicularly in the illustration of FIG. 1.

The illustration in FIG. 1 on the right shows that the reconstruction of the letter “A” in plus first order and in minus first order has spread out, the spreading out or blurring being effected perpendicular to the axis of the cylinder. A sharp reconstruction of the hologram is therefore not possible; the upper-case letter “A” can still just be discerned. Information having finer details, for example of a bar code or of a smaller script, would no longer be discernable. The resolution of the reconstructions in plus and minus first order is therefore equally poor.

FIG. 2 then shows a schematic illustration for elucidating the methods according to the invention.

The method according to the invention for the calculation of a computer-generated hologram arranged on a non-planar surface subdivides the space between hologram surface and reconstruction surface into two partial regions.

In a first partial region between the reconstruction plane and an imaginary intermediate plane, which is arranged at a short distance in front of the cylindrical hologram surface, a transformation known per se, for example, a Fourier transformation, is applied in order to calculate the propagation of the light field between the two planes. In this case, it is possible to use known algorithms, the fast Fourier transformation in this example, in order to shorten the calculation time.

In a second partial region between the intermediate plane and the non-planar, in the present case cylindrical, hologram surface, by contrast, the light propagation is estimated and not calculated.

The method for the calculation of a computer-generated hologram arranged on a cylindrical surface thus comprises the following steps:

a) on the basis of the information “A” to be reconstructed, the light field in the reconstruction plane is determined and the light field of a read beam is determined in the non-planar surface of the computer-generated hologram,

b) the light field in the intermediate plane is calculated from the propagation of the light field between the reconstruction plane and the intermediate plane by means of a transformation, and

c) the light field in the cylindrical hologram surface is estimated proceeding from the light field in the intermediate plane and the estimated light field is superimposed with the light field of the read beam in order to calculate the phase and/or amplitude information of the hologram.

Instead of an exact, but very time-consuming calculation of the propagation of the light field from each point of the reconstruction to each point of the hologram, therefore, the greatest portion of the space between reconstruction and hologram is calculated by means of a computation-time-optimized transformation and a small portion of the light propagation is estimated by means of a suitable method. By choosing a suitable estimation, the computation time for calculating each cylindrical hologram can therefore be kept so short that, with conventional computers, individual holograms can be calculated and subsequently written in short time cycles of less than 1 sec.

FIG. 2 illustrates a biconvex lens in the first partial region between the intermediate plane and the reconstruction plane. This is intended to show that said lens is used for the imaging of the reconstruction if the cylindrical hologram has been calculated by means of a Fourier transformation. If, by contrast, the hologram is calculated by means of a Fresnel transformation, for example, then the lens is not necessary.

In order to estimate the propagation of the light field in the second partial region between the intermediate plane and the cylindrical hologram surface, a phase difference field is calculated from the wavelength of the light and the distribution of the propagation time differences of the light between the intermediate plane and the hologram on the non-planar surface. Since the space in the second partial region is relatively small in comparison with the first partial region, this estimation leads to a good result in the reconstruction of the hologram thus obtained.

This is because, in step c) of the method sequence described above, the light field in the non-planar surface of the hologram is estimated by a superimposition of the light field in the intermediate plane with the phase difference field. Upon application to a cylindrical hologram surface, the method is based on the idea that the regions of the hologram surface which run transversely with respect to the cylinder axis, as the distance from the axis increases, are at an increasing distance from the intermediate plane. This distance can be converted into a phase difference distribution or into a phase difference field on the basis of the wavelength of the light of the read beam to be used and the propagation time differences that can be calculated.

In the calculation of the hologram function, that is to say the dot distribution to be written to the storage medium, it may furthermore be taken into account that the pitch of the dot distribution becomes narrower on account of the curvature of the hologram surface when viewed in the direction of the propagation of the read beam depending on the angular deviation of the surface from 90°. At small angles, although the deviation is small, the change in pitch can easily be taken into account computationally and leads to a further improvement in the quality of the reconstruction.

FIG. 3 shows such a phase difference field for a cylindrical hologram surface. The stripes lying closer and closer together outwardly are clearly discernible. The distance between two white stripes in each case corresponds here to a wavelength of the light.

FIG. 4 shows an example of the method sequence for calculating the hologram function of the computer-generated hologram on a cylindrical surface.

Proceeding from the reconstruction plane illustrated on the left with the amplitude information illustrated at the top and the phase information illustrated at the bottom, which can assume values different from zero only where an amplitude is actually present, the light propagation as far as the intermediate plane is calculated by means of an inverse Fourier transformation IFT, the amplitude distribution illustrated at the top and the phase distribution illustrated at the bottom again being obtained at this location.

The phase difference field of the cylinder phase as illustrated in FIG. 4 is subtracted from this, while the amplitude distribution remains unchanged. This yields the amplitude and phase information in the hologram plane.

As is further shown in FIG. 4, it is possible to code the amplitude and phase distribution obtained in the hologram plane to form a pure phase distribution of a phase hologram with uniformly distributed amplitude information. Such a hologram can then be written to a storage medium in a known manner.

With the above-described basic idea of estimating the propagation of the light field in the second partial region between the intermediate plane and the cylindrical hologram surface, it is also possible to carry out a method for the calculation of a reconstruction of a computer-generated hologram arranged on a non-planar surface by means of an incident light wave. This method has the following steps:

d) the light field of an incident light wave in the cylindrical hologram surface is calculated by a superimposition of the impinging light field and the phase and/or amplitude information of the hologram,

e) the light field in the intermediate plane is estimated proceeding from the non-planar surface of the hologram, and

f) the light field in the reconstruction plane is calculated from the propagation of the light field between the intermediate plane and the reconstruction plane.

In this case, too, the estimation can be carried out on the basis of a phase difference field, as has been described above.

In step e) the light field in the intermediate plane is then estimated by a superimposition of the light field in the cylindrical hologram surface with the phase difference field in accordance with FIG. 3.

FIG. 5 shows an example of the method sequence described above. The starting point is the amplitude and phase information—illustrated on the left—of the light field in the cylindrical hologram surface. The amplitude is uniformly distributed over the area of the light field, while the phase has a non-uniform distribution over the light field.

The phase difference field as cylinder phase is added to said phase information, thereby resulting in the amplitude and phase information in the intermediate plane.

Proceeding from the amplitude and phase information of the light field in the intermediate plane, the light field in the reconstruction plane is calculated by means of a Fourier transformation. The reconstruction of the letter “A” in plus and minus first order is then produced in the amplitude information.

A preferred introductory step for the method described above consists in the following:

g) the light field of a read beam, in particular of a laser beam in the form of a plane wave, is calculated or defined in the intermediate plane arranged in front of the hologram, and

h) the light field impinging on the cylindrical hologram surface is estimated proceeding from the intermediate plane.

For this purpose, in step h), the light field in the cylindrical hologram surface may be estimated by a superimposition of the light field in the intermediate plane with the cylindrical phase difference field in accordance with FIG. 3.

This procedure is illustrated in FIG. 6, which shows, in a manner similar to that in FIG. 3, a propagation of a light field that is directed in the direction of the hologram surface. Here the illustration shows the incident plane wave with a uniformly distributed amplitude information item (black) and with a uniform phase information item (white), from which the cylindrical phase difference field is subtracted. This results in a light field correspondingly with a uniform amplitude distribution with the cylindrical phase distribution. This light field can then be used for calculating the reconstruction of the hologram, as explained above.

Accordingly, in the calculation of the reconstruction that is carried out proceeding from a plane wave, the phase difference field is added to the light field twice.

Moreover, the inverse Fourier transformation and the Fourier transform and also first the subtraction and then the addition of the phase difference field are illustrated and described in FIGS. 3 to 5. This is based on the—arbitrarily chosen—convention of the direction of propagation of the light when carrying out the calculation. If the light propagation is reversed by convention then the computation operations are correspondingly reversed.

The hologram in FIG. 3 is calculated for a specific cylinder radius r₁ and a specific wavelength λ₁ of the read beam. If said hologram is then applied to a cylindrical surface having a radius r₂, the reconstruction becomes unsharp for the same reading wavelength. Since, in the case of a cylindrical surface, the distances between an intermediate plane and the cylindrical surface are approximately proportional to the inverse of the radius, the reconstruction becomes sharp by using a different wavelength λ₂=r₁/r₂ λ₁ during reading. Consequently, in the case of the cylinder, different radii can be covered by a single type of calculation with a single radius if the wavelengths are adapted to the radius during reading. This statement applies analogously to spherical surfaces.

In a further configuration of the method described above, the phase shift caused by an optical element arranged in the beam path is taken into account in the calculation of the hologram function. This case occurs if a read-out device for reading out holograms arranged on a cylindrical surface, which device is described in more detail further below, has a cylindrical lens which only partly compensates for the cylindrical phase shift. A remainder of cylinder phase then remains, which has to be taken into account in the calculation.

By way of example, the cylindrical hologram surface may have a radius r₁ of 3 mm. A cylindrical lens having a radius r₂ of 4 mm is present in the beam path of the read-out beam. The remaining cylinder effect has to be compensated for with a phase difference field based on a radius r₃ of 12 mm. This value is calculated from the difference between the reciprocal values of the radii 1/r₁−1/r₂=1/r₃. Only a phase difference field on the basis of a cylinder having a radius of 12 mm is then included in the calculation of the hologram function or the reconstruction, while the phase difference field on the basis of a cylinder having a radius of 3 mm was taken into account in the above-described calculation without a cylindrical lens in the beam path.

FIGS. 7 to 10 illustrate various holograms and the reconstructions thereof, the holograms differing in terms of their calculation but in each case using the same cylindrical hologram surface.

FIG. 7 shows, in the left-hand half, an amplitude hologram that has been calculated with a finely stepped grey-scale level distribution. The information in the hologram function has therefore been largely preserved, which can be discerned from the reproduction, which reveals only little noise besides the reproduced information.

The reproduction shows a characteristic feature of the non-planar, here cylindrical, hologram in that the plus first order illustrated at the top on the left reveals the largely sharp image of the letter “A” while the unsharp reproduction illustrated at the bottom on the right reproduces the minus first order. The minus first order is therefore considerably less sharp than the reproduction in the plus first order, that is to say it exhibits a considerably poorer resolution. In this case, the unsharpness in the reproduction is transverse with respect to the cylinder axis, which runs perpendicular according to the illustration chosen in FIGS. 7 to 10. This is in accordance, moreover, with the illustration as shown in FIG. 1 that was explained above as a starting point.

If the minus first order of FIG. 7 is compared with the minus first order in FIG. 1, then it can be discerned that the unsharpness has become significantly greater in the reproduction in accordance with FIG. 7. By contrast, however, a considerable gain in sharpness can be ascertained in comparison with FIG. 1 in the case of the plus first order.

FIG. 8 shows a binary phase hologram that has been produced from the calculation described above by means of a coding that has already been explained in connection with FIG. 4. The coding means converting the calculated hologram function, that is to say the calculated amplitude and phase information, into a quantized function in amplitude or phase. Mention is made of a binary phase hologram, therefore, if the calculated hologram function has been converted into a raster comprising individual dots, where the dots have a phase shift either of 0 or φ, where φ may assume values in the interval of between 0 and 2π.

In the reproduction of the binary phase hologram that is illustrated on the right, a sharp letter “A” can again be discerned in the plus first order illustrated at the top on the left, while the minus first order is significantly less sharp and more blurred transversely with respect to the cylinder axis. A significant noise can be discerned in the reproduction in comparison with the illustration in FIG. 7, which has arisen on account of the binarization.

FIG. 9 shows a further development of the binary phase hologram since an optimization of the binary hologram function has been calculated in this case. For this purpose, it is possible to use a generalized Gerchberg-Saxton algorithm as iterative optimization or a direct binary search as non-iterative optimization. As part of the optimization it is possible in this case to determine a region around the letter “A” which has less noise than the rest of the reproduction, as a result of which the contrast is increased in said region. It holds true in this case, too, that a different sharpness of the two reproductions is obtained, which results from the cylindrical form of the hologram.

FIG. 10 shows an example in which the hologram function has been calculated as a Fresnel amplitude hologram. An imaging lens is not used in the reproduction of this hologram, but a distance between the hologram and the reproduction is concomitantly taken into account in the calculation of the hologram function, so that a sharp reproduction arises only in the distance range of said predetermined distance. In the reproduction, only the plus first order appears and an increased proportion in zeroth order in comparison with the hologram types described above. The minus first order is blurred at close distances to such a great extent, that is to say exhibits such a poor resolution, that it cannot be discerned.

FIG. 11 shows a further example of a phase difference field, in which a spherical hologram surface has been assumed. Accordingly, the phase function has concentric rings with different phases.

The resultant amplitude hologram for the sphere surface is illustrated on the left in FIG. 12. The reproduction is illustrated on the right and again has a sharp reconstruction of the letter “A” in plus first order and an unsharp reconstruction in minus first order. In comparison with the cylindrical hologram surfaces explained above, in FIG. 12 the reconstructed letter “A” in minus first order is unsharp or blurred in all directions since there is no preferred axis.

FIGS. 13 to 15 show three exemplary embodiments of devices according to the invention for reconstructing a computer-generated hologram 4 arranged on a non-planar, here cylindrical, surface of a storage medium 2. The exemplary embodiments differ only in the arrangement of the cylindrical lens so that a description that applies to all three exemplary embodiments is specified first of all. Accordingly, the same reference symbols are used in FIGS. 13 to 15. This exemplary embodiment likewise remains valid for spherical non-planar surfaces if a spherical lens is introduced into the beam path instead of the additional cylindrical lens.

The devices have a light source 6, in the present case a laser for generating a read beam 7, and recording means 8, in the present case a CCD camera for recording the light beam 9 which is diffracted and reflected by the hologram 4 and deflected in the direction of the camera 8 by a beam splitter 10. The reconstruction of the hologram 4 then arises in the camera 8. Furthermore, a converging lens 12 is arranged in the beam path in front of the camera 8 in order to image the reconstruction in the case of a hologram calculated by means of Fourier transformation.

According to the invention, a cylindrical lens 14 for at least partly compensating for the cylindrical surface of the hologram is provided in the beam path between the laser 6 and the camera 8. By means of the cylindrical lens 14, a cylinder phase is added to the light beam 9 that has been diffracted and reflected back. The cylindrical lens is generally embodied in convex fashion for this purpose.

FIG. 13 shows, then, that the lens 14 is arranged in the beam path between the beam splitter 10 and the storage medium 2. As a result, both the read beam 7 and the reflected and diffracted light beam 9 run through the cylindrical lens 14. This is a preferred reading arrangement since the read beam is imaged on to the cylindrical surface and the reflected beam is imaged from the cylindrical surface into a plane. In this case, it is preferred for the cylindrical lens to be brought as close as possible to the cylindrical surface in order to avoid geometrical distortions.

FIG. 14 shows that the cylindrical lens 14 is arranged in the beam path between the laser 6 and the beam splitter 10. As a result, only the read beam 7 runs through the cylindrical lens 14.

Finally, FIG. 15 shows that the cylindrical lens 14 is arranged in the beam path between the beam splitter 10 and the camera 8. Consequently, only the diffracted and reflected light beam 9 runs through the cylindrical lens 14.

As has been described above, it is preferred for the incident read beam 7 in the intermediate plane to be able to be assumed to be a plane wave. This facilitates the calculation. Therefore, in the construction in accordance with FIG. 13, a concave cylindrical lens for compensating for the convex cylindrical lens 14 may be provided in the beam path between the laser 6 and the beam splitter 10. If the two cylindrical lenses compensate for one another in terms of their optical effect, then despite the cylindrical lens 14 present a plane wave arises in the intermediate plane arranged directly in front of the hologram. Since, by contrast, the diffracted and reflected light beam 9 does not pass through the concave cylindrical lens, the cylinder phase caused by the cylindrical lens 14 is preserved.

In the construction in accordance with FIG. 14, in which the convex cylindrical lens itself is only arranged in the read beam 7, such a compensation by a concave cylindrical lens cannot be provided since otherwise the effect of the cylindrical lens overall would be cancelled.

The present reading device has a construction which inherently matches, in principle, the construction of conventional reading devices. Therefore, it is preferred for the cylindrical lens 14 to be arranged such that it can be pivoted into the beam path, for example by means of a pivoting mechanism. This makes it possible to use reading devices for conventional applications and for the specific application described here.

There are two possibilities for the refractive power of the cylindrical lens, which have already been mentioned above. Firstly, the cylindrical lens 14 can completely compensate for the cylindrical hologram surface 4. A calculation of a normal planar hologram and writing to a storage medium would thus be possible without the need for application of a method according to the invention. This is because in this case the cylindrical lens 14 makes it possible to completely compensate for the optical effect brought about by the cylindrical form of the hologram surface.

If, by contrast, the hologram 4 arranged on the storage medium 2 has been calculated according to one of the methods described above such that the cylindrical hologram surface has been taken into account only in part, that is to say with a different cylinder radius, then the cylindrical lens can be chosen such that the remaining portion of the cylindrical hologram surface is compensated for by the cylindrical lens 14.

A method for producing a computer-generated hologram on a non-planar, in particular cylindrical surface is described below.

Firstly, the hologram function, that is to say the dot distribution to be written to the storage medium, is calculated with the aid of a method described above.

The resultant dot distribution is then translated to a writing device with the aid of which the hologram is written to a storage medium arranged in planar fashion. For this purpose, energy is introduced dotwise in to an optically variable material layer of the storage medium. The quantity of energy introduced results in a greater or lesser optical alteration of the material layer and hence in an optically effective dot distribution in the storage medium. In the case of a binary distribution, therefore, dots and no dots are written, by way of example. The optical effect may be a phase shift and/or an amplitude alteration.

After the completion of the dot distribution in the planar storage medium, the storage medium is fixed on a non-planar, for example, cylindrical surface of a workpiece, whereby the material layer of the storage medium that carries the hologram assumes the cylindrical form.

Afterwards, the storage medium can be read out with the aid of a conventional reading device or a reading device described above. A conventional reading device not having a cylindrical lens can be used when the hologram function has been calculated with the cylindrical phase being taken into account. By contrast, if the cylindrical phase has been taken into account only in part, or has not been taken into account at all, then the hologram can be read out with the aid of a device according to the invention, having a cylindrical lens.

For a quality control, however it is necessary to check the storage medium in a planar arrangement because generally it is not possible to bring the storage medium to a corresponding non-planar surface form. However, a storage medium arranged in the plane cannot be read out directly when the lack of planarity, that is to say the cylindrical form of the hologram surface, has been taken into account in the calculation.

In order, nevertheless, to enable a quality control, the hologram can be read out from the planar storage medium and be reconstructed, in which case one of the devices described above with reference to FIGS. 13 to 15 may be used. Instead of the convex cylindrical lenses described there for the case of a cylindrical hologram surface, in the present case, concave cylindrical lenses are used in order to introduce the lack of planarity of the cylinder form into the beam path, which is not present owing to the planarity or evenness of the storage medium.

As has already been explained above in more detail, in the calculation of the hologram function, that is to say the dot distribution to be written to the storage medium, it may be taken into account that the pitch of the dot distribution becomes narrower on account of the curvature of the hologram surface when viewed in the direction of the propagation of the read beam depending on the angular deviation of the surface from 90°. At small angles, although the deviation is small, the change in pitch can easily be taken into account computationally and leads to a further improvement in the quality of the reconstruction.

1-27. (canceled)

28. A method for calculating a light field which propagates between a non-planar surface of a computer-generated hologram and a planar reconstruction surface, comprising the steps of
(a) defining an intermediate plane arranged in front of the hologram,
(b) calculating the propagation of the light field between the reconstruction plane and the intermediate plane by means of a transformation, and
(c) estimating the propagation of the light field between the non-planar hologram surface and the intermediate plane is estimated.

29. The method according to claim 28, further comprising the steps of
(d) determining, on the basis of the information to be reconstructed, the light field in the reconstruction plane, and determining the light field of a read beam in the non-planar surface of the computer-generated hologram,
(e) calculating the light field in the intermediate plane arranged in front of the hologram from the propagation of the light field between the reconstruction plane and the intermediate plane, and
(f) estimating the light field in the non-planar surface of the computer-generated hologram proceeding from the intermediate plane and superimposing the estimated light field with the light field of the read beam in order to calculate the phase and/or amplitude information of the hologram.

30. The method according to claim 29,
(g) calculating the light field of an incident light wave in the non-planar surface of the hologram by a superimposition of the impinging light field and the phase and/or amplitude information of the hologram,
(h) estimating the light field in the intermediate plane in front of the hologram, proceeding from the non-planar surface of the hologram, and
(i) calculating the light field in the reconstruction plane from the propagation of the light field between the intermediate plane and the reconstruction plane.

31. The method according to claim 30, further comprising the steps of
(j) calculating or defining the light field of a read beam in the intermediate plane, and
(k) estimating the light field impinging in the non-planar surface of the hologram is estimated proceeding from the intermediate plane.

32. The method according to claim 29, further comprising the steps of calculating a reflection hologram or the reconstruction thereof.

33. The method according to claims 29, further comprising the steps of calculating a phase difference field from the wavelength of the light and the distribution of the propagation time differences of the light between the intermediate plane and the hologram on the non-planar surface.

34. The method according to claim 30, wherein in step (f) the light field in the non-planar surface of the hologram is estimated by a superimposition of the light field in the intermediate plane with the phase difference field.

35. The method according to claim 33, wherein in step (h), the light field in the intermediate plane is estimated by a superimposition of the light field in the non-planar surface of the hologram with the phase difference field.

36. The method according to one of claims 3 1, wherein in step (k), the light field in the non-planar surface of the hologram is estimated by a superimposition of the light field in the intermediate plane with the phase difference field.

37. The method according to claim 36, wherein the light field of the read beam is defined in the intermediate plane as a plane wave, and wherein the read beam is taken into account in the calculation by a doubling of the phase difference field between the intermediate plane and the hologram surface and the light field of the read beam is ignored afterwards.

38. The method according to claim 28, wherein an optimization algorithm is used for the calculation of the hologram.

39. The method according to claim 28, wherein the non-planar surface is calculated or approximated by means of a mathematical and/or numerical function.

40. The method according to claim 39, wherein one of a cylindrical surface, a spherical surface, a parabolic surface or a sinusoidal surface is used.

41. The method according to claim 28, wherein the phase shift caused by an optical element arranged in the beam path is taken into account.

42. The method for producing a computer-generated hologram on a non-planar surface, comprising the steps of
calculating the hologram with the aid of a method according to claim 28,
writing the hologram to a storage medium arranged in planar fashion with the aid of a writing device, and
fixing the planar storage medium on a non-planar surface, whereby the material layer of the storage medium that carries the hologram assumes the non-planar form.

43. The method according to claim 42, further comprising the step of
selecting the hologram from the planar storage medium and reconstructing the hologram for quality control, with the aid of a device according to claim 47.

44. A storage medium for a computer-generated hologram, comprising
at least one optically variable non-planar material layer in which the hologram is written,
wherein reconstructing of the hologram leads to reconstructing of the information in an order which has a better resolution in comparison with the reconstructing in the same order with an opposite sign.

45. The storage medium according to claim 44, wherein the non-planar surface is calculated or approximated by means of a mathematical and/or numerical function.

46. The Storage medium according to claim 45, wherein the non-planar surface is one of a cylindrical surface, a spherical surface, a parabolic surface or a sinusoidal surface.

47. A device for reconstructing a computer-generated hologram arranged on a non-planar surface of a storage medium, comprising
a light source,
recording means for recording the reconstruction,
an optical element for at least partly compensating for a non-planar surface disposed ill a beam path between a light source and a recording means.

48. A device according to claim 47, wherein a beam splitter (10) is provided in the beam path.

49. The device according to claim 48, wherein the optical element is arranged in the beam path between the storage medium and the beam splitter.

50. The device according to claim 48, wherein the optical element is arranged in the beam path between the light source and the beam splitter.

51. The device according to claim 48, wherein the optical element is arranged in the beam path between the beam splitter and the recording means.

52. The device according to claim 47, wherein the optical element is arranged such that it can be pivoted into the beam path.

53. The device according to claim 47, wherein the optical element completely compensates for the non-planar surface.

54. The device according to claim 47, wherein the hologram arranged on the storage medium has been calculated according to claim 37, and the optical element partly compensates for the non-planar surface.
